(19) United States
(12) Patent Application Publication
(10) Pub. No.: US 2004/0166242 A1
(43) Pub. Date: Aug. 26, 2004

(54) Substrate treating method and apparatus

(75) Inventor: Atsushi Osawa, Kyoto (JP)

Correspondence Address: OSTROLENK FABER GERB & SOFFEN, 1180 AVENUE OF THE AMERICAS, NEW YORK, NY, 100368403

(73) Assignee: Dainippon Screen Mfg. Co., Ltd.

(21) Appl. No.: 10/785,685

(22) Filed: Feb. 23, 2004

(30) Foreign Application Priority Data
Feb. 26, 2003 (JP) 2003-049236

(51) Int. Cl. B05D 3/02

(52) U.S. Cl. 427/376.1

(57) ABSTRACT

A substrate treating method and apparatus are disclosed, which are capable of treating substrates having a material of high dielectric constant, reliably at a relatively low temperature. A treating solution containing sulfuric acid (H₂SO₄) and hydrofluoric acid (HF) or sulfuric acid (H₂SO₄) and buffered hydrofluoric acid (NH₄F.HF) is used for treating substrates coated with a film including the material of high dielectric constant. The material of high dielectric constant may be treated selectively by the treating solution at the relatively low temperature.

### BACKGROUND OF THE INVENTION

(1) Field of the Invention

This invention relates to a substrate treating method and apparatus for performing a predetermined treatment of semiconductor wafers and glass substrates for liquid crystal displays (hereinafter called simply “substrates”). More particularly, the invention relates to a technique for treating substrates coated with a film containing a material of high dielectric constant.

(2) Description of the Related Art

In the semiconductor field of recent years, the increasingly refined structure of devices such as transistors has led to development of LSIs having multiple functions. While this trend has resulted in increases in the operating speed of circuits, the thin formation of gate insulating oxide film is reaching the limit. That is, an increase in leak current due to the thin film is posing a serious problem.

Then, as a means for solving this problem, materials of high dielectric constant are attracting attention as new materials capable of suppressing leak current; a possible replacement for the oxide film having been used as gate insulating film.

However, the above conventional technique has the following drawback.

The materials of high dielectric constant usable in the semiconductor field include metal oxides such as of aluminum and hafnium. However, these materials cannot be treated with solutions conventionally used in etching, polymer removal, and cleaning. Although studies are being made on materials of high dielectric constant expected to replace the conventional materials, such new materials are not in wide use yet. Moreover, it is desired to treat the materials of high dielectric constant for etching, polymer removal and cleaning at the lowest possible temperature for reduced running cost, for example.

### SUMMARY OF THE INVENTION

This invention has been made having regard to the state of the art noted above, and its object is to provide a substrate treating method and apparatus for treating substrates having a material of high dielectric constant effectively at a relatively low temperature.

The above object is fulfilled, according to this invention, by a substrate treating method wherein a substrate coated with a film including a material of high dielectric constant is treated with a treating solution containing sulfuric acid (H₂SO₄) and hydrofluoric acid (HF) or a treating solution containing sulfuric acid (H₂SO₄) and buffered hydrofluoric acid (NH₄F.HF).

Inventors herein have conducted experiment in treating a material of high dielectric constant by using a treating solution containing sulfuric acid (H₂SO₄) and hydrofluoric acid (HF) or a treating solution containing sulfuric acid (H₂SO₄) and buffered hydrofluoric acid (NH₄F.HF). It has been found as a result that a material of high dielectric constant may be treated at a relatively low temperature. The experiment has confirmed that, by treating a material of high dielectric constant using such a treating solution, the material of high dielectric constant may be treated selectively, and that substrates are free from contamination. Substrates coated with a material of high dielectric constant may be treated effectively by using a treating solution containing sulfuric acid (H₂SO₄) and hydrofluoric acid (HF) or a treating solution containing sulfuric acid (H₂SO₄) and buffered hydrofluoric acid (NH₄F.HF).

In this invention, for example, the substrate is coated with a film including the material of high dielectric constant and silicon thermal oxidation film, and the treating solution contains at most 1% by weight of hydrofluoric acid (HF) or buffered hydrofluoric acid (NH₄F.HF). The etching rate of the treating solution containing at most 1% by weight of hydrofluoric acid or buffered hydrofluoric acid acting on the material of high dielectric constant is comparable to or higher than the etching rate for silicon thermal oxidation film. Thus, when the above treating solution is used to treat substrates coated with a film including a material of high dielectric constant and silicon thermal oxidation film, the material of high dielectric constant may be treated selectively.

In this invention, the material of high dielectric constant is an oxide including at least one of aluminum Al, hafnium Hf and zirconium Zr, silicate, or aluminate, for example. Specific examples include Al₂O₃, HfSiₓO_{y}, HfO₂, HfSi^{x}O_{y}, ZrAlₓO_{y} and ZrO₂.

Preferably, the substrate is treated with the treating solution heated. While the treating invention may be heated to any desired temperature, considering a practical etching rate, running cost of the apparatus and the heat resistance of components of the apparatus, the treating solution should desirably be in a temperature range between room temperature and 100° C.

In another aspect of the invention, a substrate treating apparatus is provided for treating a substrate coated with a film including a material of high dielectric constant, the apparatus comprising:

a treating unit for receiving the substrate for treatment;

a treating solution supply device for supplying a -treating solution containing sulfuric acid (H₂SO₄) and hydrofluoric acid (HF) or a treating solution containing sulfuric acid (H₂SO₄) and buffered hydrofluoric acid (NH₄F.HF) into the treating unit; and

a heating device for heating the treating solution.

The treating solution supply device supplies a treating solution containing sulfuric acid (H₂SO₄) and hydrofluoric acid (HF) or a treating solution containing sulfuric acid (H₂SO₄) and buffered hydrofluoric acid (NH₄F.HF) into a treating unit such as a batch processing unit having a treating tank or a single-substrate processing unit that spins the substrate for treatment. By heating the treating solution with the heating device, the substrate coated with a material of high dielectric constant may be treated effectively. The apparatus according to this invention, since a treating solution containing sulfuric acid (H₂SO₄) and hydrofluoric acid (HF) or a treating solution containing sulfuric acid (H₂SO₄) and buffered hydrofluoric acid (NH₄F.HF) is used, allows the treating solution to be at a relatively low temperature, and achieves a reduction in running cost of the apparatus. The apparatus may be realized with ease since there is no need to use components that withstand high temperature.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is a graph showing results of experiment conducted with the method according to this invention;

FIG. 2 is a graph showing results of experiment for comparison purposes;

FIGS. 3A through 3C are explanatory views showing a specific treatment by the method according to this invention, in which FIG. 3A shows a state before etching, FIG. 3B shows a state after dry etching, and FIG. 3C shows a state after etching with a treating solution; and

FIG. 4 is a view showing an outline of a substrate treating apparatus according to this invention.

### DESCRIPTION OF THE PREFERRED EMBODIMENT

A preferred embodiment of this invention will be described in detail hereinafter with reference to the drawings.

<Substrate Treating Method>

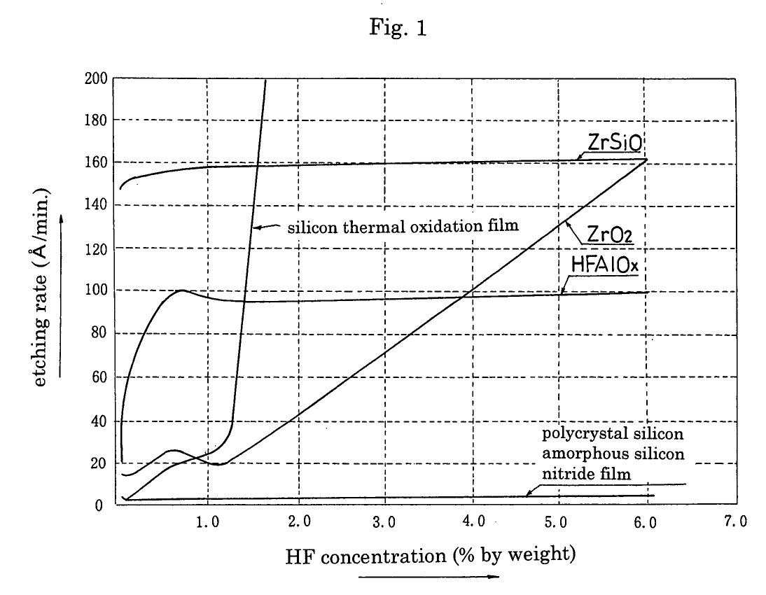

FIG. 1 is a graph showing results of experiment conducted with the method according to this invention.

This graph is a graphic representation of etching rates which are results of experiment conducted in etching substrates coated with a film containing a material of high dielectric constant. The etching process is carried out by using, as an etching solution, a treating solution with hydrofluoric acid (Hf) added to sulfuric acid (H₂SO₄) and heated to 80° C. The etching rate was measured for every hydrofluoric acid concentration while varying the weight % of hydrofluoric acid in the treating solution. The vertical axis of the graph represents etching rate (angstrom/min.), and the horizontal axis represents hydrofluoric acid concentration (% by weight).

Three different materials of high dielectric constant were used, which were ZrO₂, ZrSiO and HfAlOₓ. Further, silicon thermal oxidation film, polycrystal silicon, amorphous silicon and nitride film were used as materials for comparison.

As seen from the graph of FIG. 1, the treating solution with hydrofluoric acid added to sulfuric acid shows high etching rates for the materials of high dielectric constant at a relatively low temperature (80° C. in the experiment), regardless of the concentration of hydrofluoric acid. On the other hand, the treating solution shows low etching rates for polycrystal silicon, amorphous silicon and nitride film.

That is, where a material of high dielectric constant is used as gate insulating oxide film, the treating solution exerts very little action on the conventional materials (polycrystal silicon, amorphous silicon and nitride film) used for substrates. The experiment demonstrates that selective treatment may be performed with the above treating solution. Since the treating solution includes sulfuric acid, organic substances may be removed completely, and the substrates are free from contamination by the material of high dielectric constant dissolving from the substrates.

On the other hand, for silicon thermal oxidation film the etching rate increases sharply as the concentration of hydrofluoric acid exceeds 1% by weight. Thus, it becomes difficult to treat the material of high dielectric constant selectively. However, in the concentration range within 1% by weight of hydrofluoric acid added to sulfuric acid, the etching rate of the treating solution for the material of high dielectric constant is comparable to or higher than the etching rate for silicon thermal oxidation film. Thus, when treating substrates coated with a film including a material of high dielectric constant and silicon thermal oxidation film, the material of high dielectric constant may be treated selectively by adding hydrofluoric acid in an amount not exceeding 1% by weight.

Although the temperature of the treating solution is set to 80° C. in the above experiment, the temperature may be set as desired. Considering a practical etching rate, running cost of the apparatus and the heat resistance of components of the apparatus, it is desirable to set the temperature of the treating solution in a range of room temperature to 100° C. In the above experiment, the treating solution has hydrofluoric acid (HF) added to sulfuric acid (H₂SO₄). Similar results may be obtained where buffered hydrofluoric acid (NH₄F.HF) is added to sulfuric acid (H₂SO₄).

<Examples for Comparison>

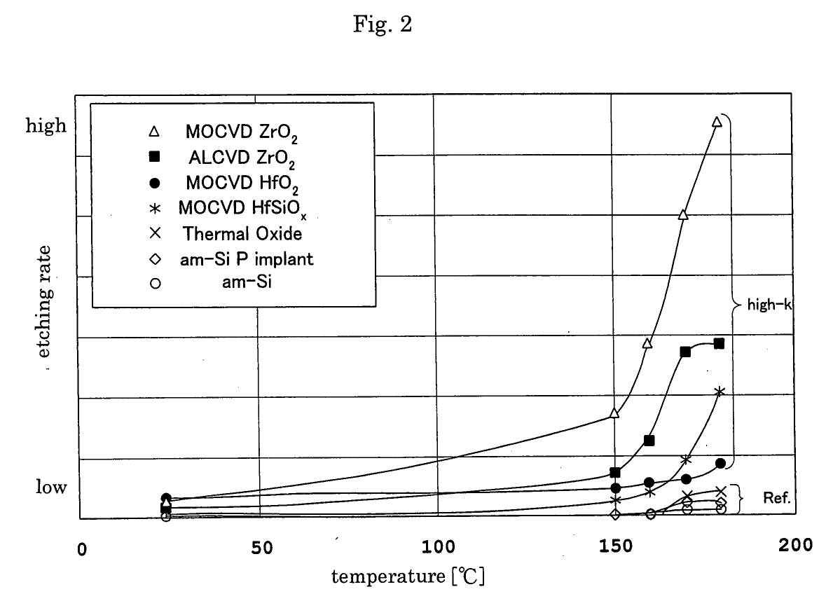

FIG. 2 shows a graph reflecting etching treatment of materials of high dielectric constant and the like with a treating solution containing sulfuric acid without hydrofluoric acid added thereto, for comparison with this invention. Here, the etching rate was measured for every temperature while varying the heating temperature of the treating solution. Specific heating temperatures were 23° C., 150° C., 160° C., 170° C. and 180° C. The maximum heating temperature was 180° C. because of the heating limit of the apparatus used in the experiment.

The materials of high dielectric constant used were zirconium Zr and hafnium Hf. Specifically, these were ZrO₂ by organic metal chemical vapor deposition (MO CVD), ZrO₂ by atomic layer chemical vapor deposition (AL CVD), and HfO₂ and HfSiOₓ by MO CVD. Three different materials, i.e. silicon thermal oxidation film, amorphous silicon with P-implant and amorphous silicon, were used for comparison with the materials of high dielectric constant.

As seen from the graph of FIG. 2, the sulfuric acid solution not containing hydrofluoric acid fails to realize a practical etching rate for materials of high dielectric constant unless the solution is heated to 100 to 200° C. That is, with the sulfuric acid solution not containing hydrofluoric acid, it is necessary to heat the treating solution to a high temperature. This raises the running cost of the treating apparatus, and requires components of the apparatus to withstand high temperature, and hence a possibility of increased manufacture cost of the apparatus.

On the other hand, with the method according to this invention, which uses a treating solution containing sulfuric acid and hydrofluoric acid or a treating solution containing sulfuric acid and buffered hydrofluoric acid, the treating temperature may be relatively low. Thus, the running cost of the apparatus may be maintained lower than with the above examples for comparison, and the apparatus may be realized with ease.

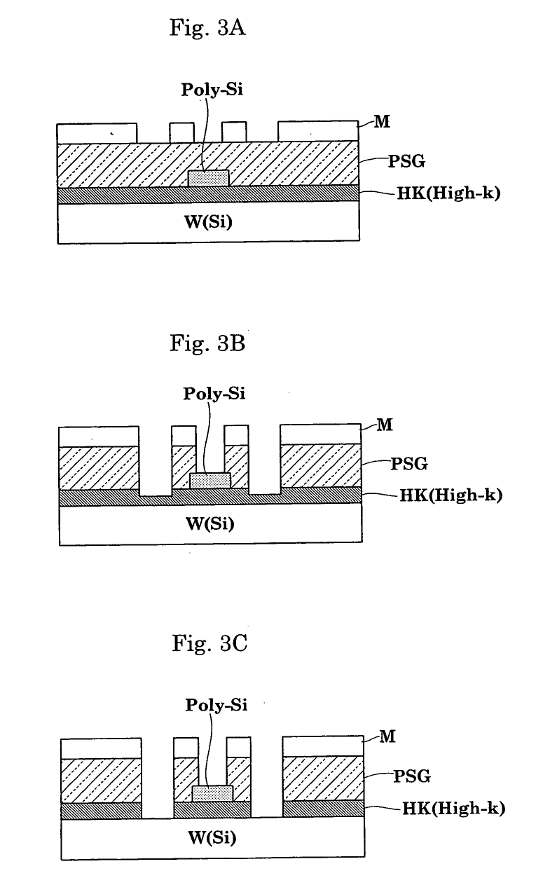

Next, a specific example of treatment by the above substrate treating method will be described briefly with reference to FIGS. 3A-3C. FIGS. 3A through 3C are explanatory views showing a specific treatment by the method according to this invention, in which FIG. 3A shows a state before etching, FIG. 3B shows a state after dry etching, and FIG. 3C shows a state after etching with the treating solution.

A wafer W has a material of high dielectric constant (High-k) HK, Poly-Si acting as gate electrodes, and PSG already formed on Si. Further a mask (resist) M is selectively formed thereon. Since the treating solution contains sulfuric acid, the mask M preferably is a material including Poly-Si, SiO₂ or SiN resistant to sulfuric acid.

As shown in FIG. 3A, the wafer W with the mask M formed thereon is dry-etched. As a result, as shown in FIG. 3B, portions of the PSG not covered by the mask M are etched, and the material of high dielectric constant (High-k) HK is dry-etched halfway in the direction of thickness.

Finally, the dry-etched wafer W is immersed in a treating solution having hydrofluoric acid added to sulfuric acid and heated to about 80° C. As a result, as shown in FIG. 3C, the remaining parts of the material of high dielectric constant (High-k) HK are etched and removed by the treating solution.

<Substrate Treating Apparatus>

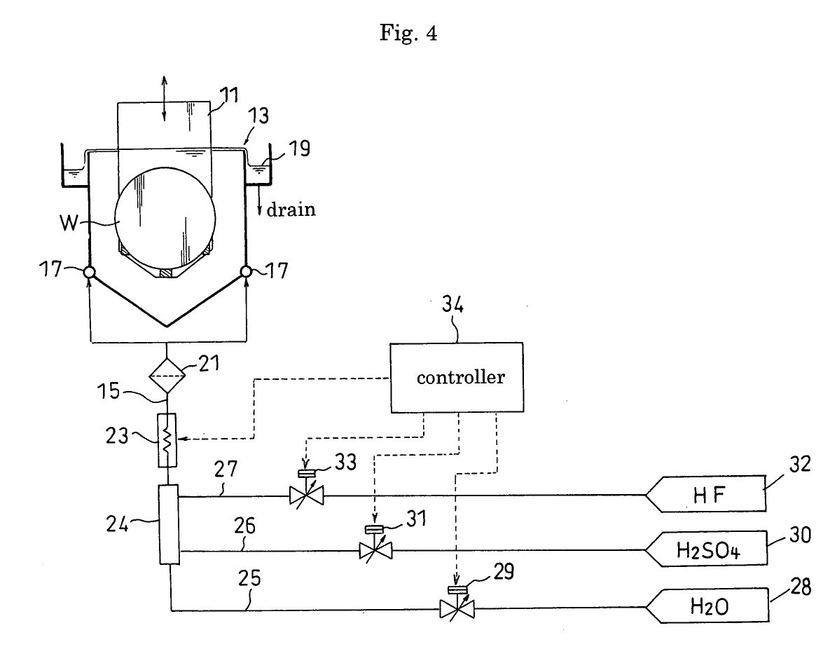

Next, a substrate treating apparatus suitable for carrying out the above substrate treating method will be described with reference to FIG. 4. FIG. 4 is a view showing an outline of a substrate treating apparatus according to this invention.

This substrate treating apparatus includes a holding arm 11, a treating tank 13 and treating solution piping 15. The holding arm 11 holds a plurality of wafers W under treatment, and is vertically movable between a position above the treating tank 13 and an immersed position (treating position) shown in FIG. 4. The treating tank 13 has injection pipes 17 arranged in bottom positions thereof for introducing the treating solution. A collecting tank 19 is formed around an upper portion of the treating tank 13 for collecting and discharging overflows of the treating solution. The treating solution piping 15 is connected to the injection pipes 17.

The treating solution piping 15 has a filter 21, a heater 23 which corresponds to the heating device in this invention, a mixer 24, a first supply line 25, a second supply line 26 and a third supply line 27. The filter 21 serves to remove particles and the like from the treating solution. The heater 23 heats and adjusts the treating solution to a predetermined temperature. The mixer 24 mixes sulfuric acid supplied through the second supply line 26 and hydrofluoric acid supplied through the third supply line 27. The first supply line 25 has a deionized water source 28 connected thereto, and a control valve 29 for opening and closing the supply line 25 and controlling the flow rate therethrough. The second supply line 26 has a sulfuric acid source 30 connected thereto and a control valve 31 for opening and closing the supply line 26 and controlling the flow rate therethrough. The third supply line 27 has a hydrofluoric acid source 32 connected thereto, and a control valve 33 for opening and closing the supply line 27 and controlling the flow rate therethrough.

A controller 34 controls opening and closing of the control valves 29, 31 and 33 and the flow rates therethrough. The controller 34 controls also the heater 23 to heat the treating solution flowing through the treating solution piping 15 to a predetermined heating temperature. Further, the controller 37 controls the control valves 31 and 33 as necessary to adjust the concentration of the treating solution.

The above treating solution piping 15 and mixer 24, supply lines 26 and 27, sulfuric acid source 30, hydrofluoric acid source 32, control valves 31 and 33 and controller 34 constitute the treating solution supply device in this invention.

In the substrate treating apparatus having the above construction, the controller 34 opens the control valves 31 and 33 to supply sulfuric acid and hydrofluoric acid at predetermined flow rates, respectively, to the mixer 24. As a result, the treating solution of predetermined concentration is supplied to the treating solution piping 15 through the mixer 24. The treating solution supplied to the treating solution piping 15 is heated to the predetermined temperature by the heater 23, and then supplied to the treating tank 13. The treating solution fills the treating tank 13 and overflows it into the collecting tank 19. Then, the holding arm 11 on standby above the treating tank 13, while holding the wafers W, descends to the immersed position shown in FIG. 4. After elapse of a predetermined time, the controller 34 closes the control valves 31 and 33, and opens the control valve 29 to supply deionized water into the treating tank 13. As a result, the etching treatment of the wafers W is stopped to give way to deionized water cleaning treatment.

The substrate treating apparatus having the above construction can carry out the foregoing substrate treating method to treat effectively the wafers W coated with a film having a material of high dielectric constant.

The foregoing apparatus has been described as treating a plurality of wafers W en bloc in a batch process. This invention is applicable also to the single-wafer processing type in which a holding device holds and spins a single wafer for treatment at a time. The apparatus described above discharges the treating solution overflowing into the collecting tank 19. Instead, the treating solution may be circulated with a pump to return to the treating tank 13. Furthermore, the heater 23 is not limited to what is mounted on the treating solution piping 15, but may be provided for the collecting tank 19. The treating solution may be other than the etching solution, such as a polymer removing solution, for example.

This invention may be embodied in other specific forms without departing from the spirit or essential attributes thereof and, accordingly, reference should be made to the appended claims, rather than to the foregoing specification, as indicating the scope of the invention.

What is claimed is:

1. A substrate treating method wherein a substrate coated with a film including a material of high dielectric constant is treated with a treating solution containing sulfuric acid (H₂SO₄) and hydrofluoric acid (HF).

2. A substrate treating method as defined in claim 1, wherein said substrate is coated with a film including the material of high dielectric constant and silicon thermal oxidation film, and said treating solution contains at most 1% by weight of hydrofluoric acid (HF).

3. A substrate treating method as defined in claim 1, wherein said material of high dielectric constant is an oxide including at least one of aluminum Al, hafnium Hf and zirconium Zr, silicate, or aluminate.

4. A substrate treating method as defined in claim 1, wherein said substrate is treated with said treating solution heated.

5. A substrate treating method as defined in claim 4, wherein said treating solution is in a temperature range between room temperature and 100° C.

6. A substrate treating method wherein a substrate coated with a film including a material of high dielectric constant is treated with a treating solution containing sulfuric acid (H₂SO₄) and buffered hydrofluoric acid (NH₄F.HF).

7. A substrate treating method as defined in claim 6, wherein said substrate is coated with a film including the material of high dielectric constant and silicon thermal oxidation film, and said treating solution contains at most 1% by weight of buffered hydrofluoric acid (NH₄F.HF).

8. A substrate treating method as defined in claim 6, wherein said material of high dielectric constant is an oxide including at least one of aluminum Al, hafnium Hf and zirconium Zr, silicate, or aluminate.

9. A substrate treating method as defined in claim 6, wherein said substrate is treated with said treating solution heated.

10. A substrate treating method as defined in claim 9, wherein said treating solution is in a temperature range between room temperature and 100° C.

11. A substrate treating apparatus for treating a substrate coated with a film including a material of high dielectric constant, said apparatus comprising:
a treating unit for receiving said substrate for treatment;
treating solution supply means for supplying a treating solution containing sulfuric acid (H₂SO₄) and hydrofluoric acid (HF) into said treating unit; and
heating means for heating said treating solution.

12. A substrate treating apparatus as defined in claim 11, wherein said treating solution supply means is arranged to supply said treating solution containing at most 1% by weight of hydrofluoric acid (HF).

13. A substrate treating apparatus as defined in claim 11, wherein said heating means is arranged to heat said treating solution to be in a temperature range between room temperature and 100° C.

14. A substrate treating apparatus for treating a substrate coated with a film including a material of high dielectric constant, said apparatus comprising:
a treating unit for receiving said substrate for treatment;
treating solution supply means for supplying a treating solution containing sulfuric acid (H₂SO₄) and buffered hydrofluoric acid (NH₄F—HF) into said treating unit; and
heating means for heating said treating solution.

15. A substrate treating apparatus as defined in claim 14, wherein said treating solution supply means is arranged to supply said treating solution containing at most 1% by weight of buffered hydrofluoric acid (NH₄F.HF).

16. A substrate treating apparatus as defined in claim 14, wherein said heating means is arranged to heat said treating solution to be in a temperature range between room temperature and 100° C.
